(19) United States
(12) Patent Application Publication
(10) Pub. No.: US 2026/0323517 A1
(43) Pub. Date: Oct. 15, 2026

(54) COMMUNICATION METHOD AND APPARATUS

(71) Applicant: HUAWEI TECHNOLOGIES CO., LTD., Shenzhen (CN)

(72) Inventors: Dongdong Wei, Shenzhen (CN); Hao Tang, Shanghai (CN); Fan Wang, Shanghai (CN); Ting Wang, Shanghai (CN)

(73) Assignee: HUAWEI TECHNOLOGIES CO., LTD., Shenzhen (CN)

(21) Appl. No.: 19/467,561

(22) Filed: Feb. 2, 2026

Related U.S. Application Data
(63) Continuation of application No. PCT/CN2023/110209, filed on Jul. 31, 2023.

(51) Int. Cl. H04W 52/02

(52) U.S. Cl. CPC H04W 52/0229

(57) ABSTRACT

A terminal device detects a synchronization signal; the terminal device determines an operating mode of a cell based on the synchronization signal, where the cell supports at least two operating modes with different energy consumption, and the operating mode of the cell has a mapping relationship with at least one of the following: raster information of the synchronization signal and a type of the synchronization signal; and the terminal device accesses a network based on the operating mode of the cell. According to this method, the terminal device can quickly obtain an operating mode of a current cell after being powered on, and further access a network based on the operating mode of the cell.

### CROSS-REFERENCE TO RELATED APPLICATIONS

This application is a continuation of International Application No. PCT/CN2023/110209, filed on Jul. 31, 2023, the disclosure of which is hereby incorporated by reference in its entirety.

### TECHNICAL FIELD

The present disclosure relates to the communication field, and more specifically, to a communication method and apparatus.

### BACKGROUND

Wireless networks are being rapidly constructed to satisfy the growing demand cellular communications. As a wireless network scale increases, network energy consumption increases continuously. A current overall 5G energy saving technical system includes device-level, site-level, and network-level energy savings. To reduce energy consumption on a network side, in a next-generation communication system, the network side supports at least two operating modes with different energy consumption. How to quickly obtain an operating mode of a current cell after a terminal is powered on would be helpful for managing power consumption and is an urgent problem to be resolved.

### SUMMARY

The present disclosure provides a communication method and apparatus in which a terminal device can quickly obtain an operating mode of a current cell after being powered on, and further access a network based on the operating mode of the cell.

According to a first aspect, a communication method is provided. The method may be performed by a terminal device, or may be performed by a chip or a circuit disposed in the terminal device. This is not limited in the present disclosure. The method includes:

The terminal device detects a synchronization signal; the terminal device determines an operating mode of a cell based on the synchronization signal, where the cell supports at least two operating modes with different energy consumption, and the operating mode of the cell has a mapping relationship with at least one of the following: raster information of the synchronization signal and a type of the synchronization signal; and the terminal device accesses a network based on the operating mode of the cell.

It should be understood that a specific quantity of operating modes supported by the cell is not limited in this embodiment of the present disclosure. Specifically, the cell supports N operating modes with different energy consumption, where N is a positive integer greater than or equal to 2.

In an example, the cell supports two operating modes: an energy saving mode and a transmission enhancement mode, and the two operating modes have different energy consumption.

In another example, the cell supports four operating modes: a first energy saving mode, a second energy saving mode, a first transmission enhancement mode, and a second transmission enhancement mode, and the four operating modes have different energy consumption.

Based on the foregoing solution, after detecting the synchronization signal, the terminal device can determine the operating mode of the cell based on the raster information of the synchronization signal or the type of the synchronization signal, and access the network based on the operating mode of the cell.

With reference to the first aspect, in some implementations of the first aspect, that the terminal device determines the operating mode of the cell based on the synchronization signal includes: determining the operating mode of the cell based on the synchronization signal and a first association relationship, where the first association relationship includes an association relationship between the raster information of the synchronization signal and the operating mode of the cell, and/or an association relationship between the type of the synchronization signal and the operating mode of the cell.

By way of example but not limitation, N operating modes and N types of synchronization rasters are defined, and the N operating modes are in one-to-one correspondence with the N types of synchronization rasters, where a first-type synchronization raster is associated with a first operating mode, a second-type synchronization raster is associated with a second operating mode, and N is a positive integer greater than or equal to 2.

By way of example but not limitation, M operating modes and M types of synchronization signals are defined, and the M operating modes are in one-to-one correspondence with the M types of synchronization signals, where a first-type synchronization signal is associated with a first operating mode, a second-type synchronization signal is associated with a second operating mode, and M is a positive integer greater than or equal to 2.

Based on the foregoing method, after detecting the synchronization signal, the terminal device can determine the operating mode of the cell based on the first association relationship, thereby improving efficiency of determining the operating mode of the cell by the terminal device.

With reference to the first aspect, in some implementations of the first aspect, the raster information of the synchronization signal includes one or more of the following: a frequency domain offset, a frequency domain interval, and a global synchronization channel number GSCN calculation manner.

It should be understood that when a network device switches between different operating modes, the raster information of the synchronization signal sent by the network device also correspondingly changes.

It should be understood that types of synchronization signals (or associated synchronization signals) placed on synchronization rasters of different raster types are not limited in the present disclosure. For example, types of synchronization signals associated with different synchronization rasters can be different. The difference can be reflected in a sequence type (for example, a ZC (Zadoff-Chu) sequence or an m sequence), a sequence length (for example, a long sequence and a short sequence), and the like.

Based on the foregoing solution, a plurality of types of synchronization rasters are defined in this embodiment of the present disclosure, so that the terminal device can determine the operating mode of the cell based on the raster information of the synchronization signal.

With reference to the first aspect, in some implementations of the first aspect, different types of synchronization signals have a same center frequency, and the type of the synchronization signal is identified based on one or more of the following: a sequence type of the synchronization signal; a sequence length of the synchronization signal; or composition of the synchronization signal, where the synchronization signal includes one or more of a primary synchronization signal (PSS), a secondary synchronization signal (SSS), a master information block (MIB), and a timing indication signal.

For example, to improve frequency scanning accuracy of synchronization signals with different sequence lengths, a sequence with a short sequence length (referred to as a short sequence below) can be a middlemost part intercepted from a sequence with a long sequence length (referred to as a long sequence below). Specifically, the length of the short sequence is N, the length of the long sequence is M, and the short sequence corresponds to N middlemost bits in the long sequence M.

Based on the foregoing solution, a plurality of types of synchronization signals are defined in this embodiment of the present disclosure, so that the terminal device can determine the operating mode of the cell based on the sequence type or the sequence length of the synchronization signal, or the composition of the synchronization signal.

With reference to the first aspect, in some implementations of the first aspect, one or more of the following of the cell vary with operating modes with different energy consumption: a common signal periodicity of the cell, an access procedure of the cell, a system information obtaining manner of the cell, a time domain position of a transmission resource of the cell, a frequency domain position of the transmission resource of the cell, a function supported by the cell, and a hardware resource of the cell.

For example, a minimum system information obtaining manner of the cell is that a network side actively performs broadcasting, or sending is performed under triggering of a request of the terminal device, where minimum system information includes at least one of a master information block MIB and a system information block 1 (SIB1), and the SIB1 may also be referred to as remaining minimum system information (RMSI).

For example, an access type of the cell includes that the access procedure is based on a preamble sequence, or the access procedure is based on a wake-up signal sent by the terminal device.

For example, the common signal periodicity of the cell includes: 5 ms, 10 ms, 20 ms, 40 ms, 80 ms, and 160 ms. Common signals of the cell include a primary synchronization signal, a secondary synchronization signal, a physical broadcast channel, a system information block 1 (SIB1), and the like. It should be understood that the common signal periodicity of the cell may be periodicities of the one or more common signals.

For example, the transmission resource of the cell includes the time domain position of the transmission resource, the frequency domain position of the transmission resource, a space domain resource of the transmission resource, transmit power of the cell, a bandwidth of the cell, and the like.

For example, a feature and the function supported by the cell include whether the cell supports small packet (small data) transmission, whether the cell supports a multicast service, and the like.

For example, the hardware resource of the cell includes a quantity of antennas supported by the cell, quantization precision of digital-to-analog conversion/analog-to-digital conversion, and the like.

Based on the foregoing solution, the terminal device can determine, based on the raster information of the synchronization signal or the type of the synchronization signal, information such as the common signal periodicity, the access procedure, the system information obtaining manner, the time domain position of the transmission resource, the frequency domain position of the transmission resource, the function supported by the cell, and the hardware resource of the cell in the operating modes with different energy consumption, so as to access the network based on the foregoing content.

With reference to the first aspect, in some implementations of the first aspect, the first association relationship is protocol-defined, or before the terminal device detects the synchronization signal, the method further includes: receiving a first message, where the first message includes the first association relationship.

Based on the foregoing solution, the first association relationship can be protocol-defined or broadcast by the network device, and the terminal device can quickly determine the operating mode of the cell based on the first association relationship.

According to a second aspect, a communication method is provided. The method may be performed by a network device, or may be performed by a chip or a circuit disposed in the network device. This is not limited in the present disclosure. The method includes:

The network device determines a synchronization signal based on an operating mode of a cell, where the cell supports at least two operating modes with different energy consumption, and the operating mode of the cell has a mapping relationship with at least one of the following: raster information of the synchronization signal and a type of the synchronization signal; and the network device sends the synchronization signal.

It should be understood that a specific quantity of operating modes supported by the cell is not limited in this embodiment of the present disclosure. Specifically, the cell supports N operating modes with different energy consumption, where N is a positive integer greater than or equal to 2.

In an example, the cell supports two operating modes: an energy saving mode and a transmission enhancement mode, and the two operating modes have different energy consumption.

In another example, the cell supports four operating modes: a first energy saving mode, a second energy saving mode, a first transmission enhancement mode, and a second transmission enhancement mode, and the four operating modes have different energy consumption.

Based on the foregoing solution, the network device can determine the raster information of the synchronization signal and/or the type of the synchronization signal based on the operating mode of the cell, so that a terminal device can quickly determine the operating mode of the cell after detecting the synchronization signal.

With reference to the second aspect, in some implementations of the second aspect, that the network device determines the synchronization signal based on the operating mode of the cell includes: The network device determines the synchronization signal based on the operating mode of the cell and a first association relationship, where the first association relationship includes an association relationship between the raster information of the synchronization signal and the operating mode of the cell, and/or an association relationship between the type of the synchronization signal and the operating mode of the cell.

By way of example but not limitation, N operating modes and N types of synchronization rasters are defined, and the N operating modes are in one-to-one correspondence with the N types of synchronization rasters, where a first-type synchronization raster is associated with a first operating mode, a second-type synchronization raster is associated with a second operating mode, and N is a positive integer greater than or equal to 2.

By way of example but not limitation, M operating modes and M types of synchronization signals are defined, and the M operating modes are in one-to-one correspondence with the M types of synchronization signals, where a first-type synchronization signal is associated with a first operating mode, a second-type synchronization signal is associated with a second operating mode, and M is a positive integer greater than or equal to 2.

Based on the foregoing method, after detecting the synchronization signal, the terminal device can determine the operating mode of the cell based on the first association relationship, thereby improving efficiency of determining the operating mode of the cell by the terminal device.

With reference to the second aspect, in some implementations of the second aspect, the raster information of the synchronization signal includes one or more of the following: a frequency domain offset, a frequency domain interval, and a global synchronization channel number GSCN calculation manner.

It should be understood that when the network device switches between different operating modes, the raster information of the synchronization signal sent by the network device also correspondingly changes.

It should be understood that types of synchronization signals (or associated synchronization signals) placed on synchronization rasters of different raster types are not limited in the present disclosure. For example, types of synchronization signals associated with different synchronization rasters can be different. The difference can be reflected in a sequence type (for example, a ZC (Zadoff-Chu) sequence or an m sequence), a sequence length (for example, a long sequence and a short sequence), and the like.

Based on the foregoing solution, a plurality of types of synchronization rasters are defined in this embodiment of the present disclosure, so that the terminal device can determine the operating mode of the cell based on the raster information of the synchronization signal.

With reference to the second aspect, in some implementations of the second aspect, different types of synchronization signals have a same center frequency, and the type of the synchronization signal is identified based on one or more of the following: a sequence type of the synchronization signal; a sequence length of the synchronization signal; or composition of the synchronization signal, where the synchronization signal includes one or more of a primary, synchronization signal PSS, a secondary synchronization signal SSS, a master information block MIB, and a timing indication signal.

For example, to improve frequency scanning accuracy of synchronization signals with different sequence lengths, a sequence with a short sequence length (referred to as a short sequence below) can be a middlemost part intercepted from a sequence with a long sequence length (referred to as a long sequence below). Specifically, the length of the short sequence is N, the length of the long sequence is M, and the short sequence corresponds to N middlemost bits in the long sequence M.

Based on the foregoing solution, a plurality of types of synchronization signals are defined in this embodiment of the present disclosure, so that the terminal device can determine the operating mode of the cell based on the sequence type or the sequence length of the synchronization signal, or the composition of the synchronization signal.

With reference to the second aspect, in some implementations of the second aspect, one or more of the following of the cell vary with operating modes with different energy consumption: a common signal periodicity of the cell, an access procedure of the cell, a system information obtaining manner of the cell, a time domain position of a transmission resource of the cell, a frequency domain position of the transmission resource of the cell, a function supported by the cell, and a hardware resource of the cell.

Based on the foregoing solution, the terminal device can determine, based on the raster information of the synchronization signal or the type of the synchronization signal, information such as the common signal periodicity, the access procedure, the system information obtaining manner, the time domain position of the transmission resource, the frequency domain position of the transmission resource, the function supported by the cell, and the hardware resource of the cell in the operating modes with different energy consumption, so as to access a network based on the foregoing content.

With reference to the second aspect, in some implementations of the second aspect, the first association relationship is protocol-defined, or before the network device sends the synchronization signal, the method further includes: sending a first message, where the first message includes the first association relationship.

Based on the foregoing solution, the first association relationship can be protocol-defined or broadcast by the network device, and the terminal device can quickly determine the operating mode of the cell based on the first association relationship.

According to a third aspect, a communication method is provided. The method may be performed by a terminal device, or may be performed by a chip or a circuit disposed in the terminal device. This is not limited in the present disclosure. The method includes:

The terminal device detects a synchronization signal; the terminal device determines a target transmission reception point (TRP) type from at least two TRP types based on raster information of the synchronization signal, where the at least two TRP types correspond to different access parameters; and the terminal device accesses a network based on the target TRP type.

It should be understood that access parameters corresponding to different TRP types are protocol-specified, or are preconfigured, and the terminal device can determine the corresponding access parameters based on the TRP types.

By way of example but not limitation, the access parameters corresponding to different TRP types include at least one of the following: an uplink timing relationship, a downlink timing relationship, and a frequency offset between the terminal device and a TRP.

Optionally, the TRP type can be replaced with a base station type or a cell type. In other words, the terminal device can determine the base station type or the cell type based on the raster information of the synchronization signal.

Based on the foregoing solution, after detecting the synchronization signal, the terminal device can determine the TRP type/base station type/cell type based on the raster information of the synchronization signal, and then access the network based on the TRP type/base station type/cell type.

With reference to the third aspect, in some implementations of the third aspect, the raster information of the synchronization signal includes one or more of the following: a frequency domain offset, a frequency domain interval, and a global synchronization channel number GSCN calculation manner.

Based on the foregoing solution, a plurality of types of synchronization rasters are defined in this embodiment of the present disclosure, so that the terminal device can determine an operating mode of a cell based on the raster information of the synchronization signal.

According to a fourth aspect, a communication method is provided. The method may be performed by a network device, or may be performed by a chip or a circuit disposed in the network device. This is not limited in the present disclosure. The method includes:

The network device determines raster information of a synchronization signal based on a transmission reception point TRP type; and the network device sends the synchronization signal based on the raster information of the synchronization signal.

By way of example but not limitation, the TRP type can include a terrestrial network (TN) TRP and a non-terrestrial network (NTN) TRP.

Optionally, the TRP type can be replaced with a base station type or a cell type. In other words, a terminal device can determine the base station type or the cell type based on the raster information of the synchronization signal.

Based on the foregoing solution, the network device determines the raster information of the synchronization signal based on the TRP type/base station type/cell type, so that after detecting the synchronization signal, the terminal device can determine the TRP type/base station type/cell type based on the raster information of the synchronization signal, and further access a network based on the TRP type/base station type/cell type.

With reference to the fourth aspect, in some implementations of the fourth aspect, the raster information of the synchronization signal includes one or more of the following: a frequency domain offset, a frequency domain interval, and a global synchronization channel number GSCN calculation manner.

Based on the foregoing solution, a plurality of types of synchronization rasters are defined in this embodiment of the present disclosure, so that the terminal device can determine an operating mode of a cell based on the raster information of the synchronization signal.

According to a fifth aspect, a method is provided. The method may be performed by a terminal device, or may be performed by a chip or a circuit disposed in the terminal device. This is not limited in the present disclosure. The method includes:

The terminal device detects a synchronization signal; the terminal device determines first information based on the synchronization signal, where the first information is associated with energy consumption of a cell, the first information includes one or more of a common signal periodicity of the cell, an access procedure of the cell, a system information obtaining manner of the cell, and a time domain position of a transmission resource of the cell, a frequency domain position of the transmission resource of the cell, and the first information has a mapping relationship with at least one of the following: raster information of the synchronization signal and a type of the synchronization signal; and the terminal device accesses a network based on the first information.

Based on the foregoing solution, after detecting the synchronization signal, the terminal device can determine one or more operating parameters of the cell based on the raster information of the synchronization signal or the type of the synchronization signal, and access the network based on the operating parameters of the cell.

With reference to the fifth aspect, in some implementations of the fifth aspect, that the terminal device determines the first information based on the synchronization signal includes: determining the first information based on the synchronization signal and a second association relationship, where the second association relationship includes an association relationship between the raster information of the synchronization signal and the first information, and/or an association relationship between the type of the synchronization signal and an operating mode of the cell.

By way of example but not limitation, the second association relationship includes an association relationship between a system information obtaining manner of the cell and the type of the synchronization signal. Specifically, when remaining minimum system information of the cell is actively broadcast by a network side, a corresponding synchronization raster is a first-type synchronization raster; or when remaining minimum system information of the cell is sent under triggering of a request of the terminal device, a corresponding synchronization raster is a second-type synchronization raster. In this case, if the minimum system information is actively broadcast by the network side, the cell sends the synchronization signal on the first-type synchronization raster.

By way of example but not limitation, the second association relationship includes an association relationship between a system information obtaining manner of the cell and the type of the synchronization signal. Specifically, when remaining minimum system information of the cell is actively broadcast by a network side, a corresponding synchronization signal is a first-type synchronization signal; or when remaining minimum system information of the cell is sent under triggering of a request of the terminal device, a corresponding synchronization signal is a second-type synchronization signal. In this case, if the remaining minimum system information is actively broadcast by the network side, the cell sends the first-type synchronization signal. A sequence length of the first-type synchronization signal is 100 bits, and a sequence length of the second-type synchronization signal is 200 bits.

It should be understood that when an operating parameter in the second association relationship changes, the raster information of the synchronization signal sent by a network device and/or the type of the synchronization signal also correspondingly change.

With reference to the fifth aspect, in some implementations of the fifth aspect, the raster information of the synchronization signal includes one or more of the following: a frequency domain offset, a frequency domain interval, and a global synchronization channel number GSCN calculation manner.

Based on the foregoing solution, a plurality of types of synchronization rasters are defined in this embodiment of the present disclosure, so that the terminal device can determine the operating parameter of the cell based on the raster information of the synchronization signal.

With reference to the fifth aspect, in some implementations of the fifth aspect, different types of synchronization signals have a same center frequency, and the type of the synchronization signal is identified based on one or more of the following: a sequence type of the synchronization signal; a sequence length of the synchronization signal; or composition of the synchronization signal, where the synchronization signal includes one or more of a primary synchronization signal PSS, a secondary synchronization signal SSS, a master information block MIB, and a timing indication signal.

For example, to improve frequency scanning accuracy of synchronization signals with different sequence lengths, a sequence with a short sequence length (referred to as a short sequence below) can be a middlemost part intercepted from a sequence with a long sequence length (referred to as a long sequence below). Specifically, the length of the short sequence is N, the length of the long sequence is M, and the short sequence corresponds to N middlemost bits in the long sequence M.

Based on the foregoing solution, a plurality of types of synchronization signals are defined in this embodiment of the present disclosure, so that the terminal device can determine the operating parameter of the cell based on the sequence type or the sequence length of the synchronization signal, or the composition of the synchronization signal.

With reference to the fifth aspect, in some implementations of the fifth aspect, the second association relationship is protocol-defined, or before the terminal device detects the synchronization signal, the method further includes: receiving a second message, where the second message includes the second association relationship.

Based on the foregoing solution, the second association relationship can be protocol-defined or broadcast by the network device, and the terminal device can quickly determine the operating parameter of the cell based on the second association relationship.

According to a sixth aspect, a communication method is provided. The method may be performed by a network device, or may be performed by a chip or a circuit disposed in the network device. This is not limited in the present disclosure. The method includes:

The network device determines a synchronization signal based on first information, where the first information is associated with energy consumption of a cell, the first information includes one or more of a common signal periodicity of the cell, an access procedure of the cell, a system information obtaining manner of the cell, and a time domain position of a transmission resource of the cell, a frequency domain position of the transmission resource of the cell, and the first information has a mapping relationship with at least one of the following: raster information of the synchronization signal and a type of the synchronization signal; and the network device sends the synchronization signal.

Based on the foregoing solution, the network device determines the synchronization signal based on one or more operating parameters of the cell, so that after detecting the synchronization signal, a terminal device can determine the one or more operating parameters of the cell based on the raster information of the synchronization signal or the type of the synchronization signal, and access a network based on the operating parameters of the cell.

With reference to the sixth aspect, in some implementations of the sixth aspect, that the network device determines the synchronization signal based on the first information includes: determining the synchronization signal based on the first information and a second association relationship, where the second association relationship includes an association relationship between the raster information of the synchronization signal and the first information, and/or an association relationship between the type of the synchronization signal and an operating mode of the cell.

For related descriptions of the second association relationship, refer to the fifth aspect. Details are not described herein again.

With reference to the sixth aspect, in some implementations of the sixth aspect, the raster information of the synchronization signal includes one or more of the following: a frequency domain offset, a frequency domain interval, and a global synchronization channel number GSCN calculation manner.

Based on the foregoing solution, a plurality of types of synchronization rasters are defined in this embodiment of the present disclosure, so that the terminal device can determine the operating parameter of the cell based on the raster information of the synchronization signal.

With reference to the sixth aspect, in some implementations of the sixth aspect, different types of synchronization signals have a same center frequency, and the type of the synchronization signal is identified based on one or more of the following: a sequence type of the synchronization signal; a sequence length of the synchronization signal; or composition of the synchronization signal, where the synchronization signal includes one or more of a primary synchronization signal PSS, a secondary synchronization signal SSS, a master information block MIB, and a timing indication signal.

Based on the foregoing solution, a plurality of types of synchronization signals are defined in this embodiment of the present disclosure, so that the terminal device can determine the operating parameter of the cell based on the sequence type or the sequence length of the synchronization signal, or the composition of the synchronization signal.

With reference to the sixth aspect, in some implementations of the sixth aspect, the second association relationship is protocol-defined, or before the terminal device detects the synchronization signal, the method further includes: receiving a second message, where the second message includes the second association relationship.

Based on the foregoing solution, the second association relationship can be protocol-defined or broadcast by the network device, and the terminal device can quickly determine the operating parameter of the cell based on the second association relationship.

According to a seventh aspect, a communication apparatus is provided. The apparatus includes a transceiver unit and a processing unit. The transceiver unit is configured to detect a synchronization signal; the processing unit is configured to determine an operating mode of a cell based on the synchronization signal, where the cell supports at least two operating modes with different energy consumption, and the operating mode of the cell has a mapping relationship with at least one of the following: raster information of the synchronization signal and a type of the synchronization signal; and the processing unit is further configured to access a network based on the operating mode of the cell.

It should be understood that, the seventh aspect is an implementation on an apparatus side corresponding to the first aspect. Supplements, explanations, and descriptions of beneficial effects of the first aspect are also applicable to the seventh aspect. Details are not described again.

According to an eighth aspect, a communication apparatus is provided. The apparatus includes a transceiver unit and a processing unit. The processing unit is configured to determine a synchronization signal based on an operating mode of a cell, where the cell supports at least two operating modes with different energy consumption, and the operating mode of the cell has a mapping relationship with at least one of the following: raster information of the synchronization signal and a type of the synchronization signal; and the transceiver unit is configured to send the synchronization signal.

It should be understood that, the eighth aspect is an implementation on an apparatus side corresponding to the second aspect. Supplements, explanations, and descriptions of beneficial effects of the second aspect are also applicable to the eighth aspect. Details are not described again.

According to a ninth aspect, a communication apparatus is provided. The apparatus includes a transceiver unit and a processing unit. The transceiver unit is configured to detect a synchronization signal; the processing unit is configured to determine a target transmission reception point TRP type from at least two TRP types based on raster information of the synchronization signal, where the at least two TRP types correspond to different access parameters; and the processing unit is further configured to access a network based on the target TRP type.

It should be understood that, the ninth aspect is an implementation on an apparatus side corresponding to the third aspect. Supplements, explanations, and descriptions of beneficial effects of the third aspect are also applicable to the ninth aspect. Details are not described again.

According to a tenth aspect, a communication apparatus is provided. The apparatus includes a transceiver unit and a processing unit. The processing unit is configured to determine raster information of a synchronization signal based on a transmission reception point TRP type; and the transceiver unit is configured to send the synchronization signal.

It should be understood that, the tenth aspect is an implementation on an apparatus side corresponding to the fourth aspect. Supplements, explanations, and descriptions of beneficial effects of the fourth aspect are also applicable to the tenth aspect. Details are not described again.

According to an eleventh aspect, a communication apparatus is provided. The apparatus includes a transceiver unit and a processing unit. The transceiver unit is configured to detect a synchronization signal; the processing unit is configured to determine first information based on the synchronization signal, where the first information is associated with energy consumption of a cell, the first information includes one or more of a common signal periodicity of the cell, an access procedure of the cell, a system information obtaining manner of the cell, and a time domain position of a transmission resource of the cell, a frequency domain position of the transmission resource of the cell, and the first information has a mapping relationship with at least one of the following: raster information of the synchronization signal and a type of the synchronization signal; and the processing unit is further configured to access a network based on the first information.

It should be understood that, the eleventh aspect is an implementation on an apparatus side corresponding to the fifth aspect. Supplements, explanations, and descriptions of beneficial effects of the fifth aspect are also applicable to the eleventh aspect. Details are not described again.

According to a twelfth aspect, a communication apparatus is provided. The apparatus includes a transceiver unit and a processing unit. The processing unit is configured to determine a synchronization signal based on first information, where the first information is associated with energy consumption of a cell, the first information includes one or more of a common signal periodicity of the cell, an access procedure of the cell, a system information obtaining manner of the cell, and a time domain position of a transmission resource of the cell, and a frequency domain position of the transmission resource of the cell, and the first information has a mapping relationship with at least one of the synchronization signal and a type of the synchronization signal; and the transceiver unit is configured to send the synchronization signal.

It should be understood that, the twelfth aspect is an implementation on an apparatus side corresponding to the sixth aspect. Supplements, explanations, and descriptions of beneficial effects of the sixth aspect are also applicable to the twelfth aspect. Details are not described again.

According to a thirteenth aspect, the present disclosure provides a communication apparatus, where the communication apparatus includes a processor, configured to implement the method according to the first aspect to the eleventh aspect or any implementation of the first aspect to the eleventh aspect. The processor is coupled to a memory, the memory is configured to store instructions and data, and when the processor executes the instructions stored in the memory, the method according to the first aspect to the eleventh aspect or any implementation of the first aspect to the eleventh aspect may be implemented.

Optionally, the communication apparatus may further include the memory. Optionally, the communication apparatus may further include a communication interface. The communication interface is used by the apparatus to communicate with another device. For example, the communication interface may be a transceiver, a hardware circuit, a bus, a module, a pin, or another type of communication interface.

In an example, the communication apparatus may be a network device, for example, an access network device, may be an apparatus, a module, a chip, or the like disposed in the network device, or may be an apparatus that can be used in a matching manner with the network device.

In another example, the communication apparatus may be a terminal device, may be an apparatus, a module, a chip, or the like disposed in the terminal device, or may be an apparatus that can be used in a matching manner with the terminal device.

According to a fourteenth aspect, the present disclosure provides a communication system, including a network device and a terminal device.

According to a fifteenth aspect, the present disclosure further provides a computer program. When the computer program is executed on a computer, the computer is caused to perform the method according to the first aspect to the eleventh aspect or any implementation of the first aspect to the eleventh aspect.

According to a sixteenth aspect, the present disclosure further provides a computer program product, including instructions. When the instructions are executed on a computer, the computer is caused to perform the method according to the first aspect to the eleventh aspect or any implementation of the first aspect to the eleventh aspect.

According to a seventeenth aspect, the present disclosure further provides a computer-readable storage medium. The computer-readable storage medium stores a computer program or instructions, and when the computer program or the instructions are executed on a computer, the computer is caused to perform the method according to the first aspect to the eleventh aspect or any implementation of the first aspect to the eleventh aspect.

According to an eighteenth aspect, the present disclosure further provides a chip. The chip is configured to read a computer program stored in a memory, to perform the method according to the first aspect to the eleventh aspect or any implementation of the first aspect to the eleventh aspect; or the chip is configured to perform the method according to the first aspect to the eleventh aspect or any implementation of the first aspect to the eleventh aspect.

According to a nineteenth aspect, the present disclosure further provides a chip system. The chip system includes a processor, configured to support an apparatus in implementing the method according to the first aspect to the eleventh aspect or any implementation of the first aspect to the eleventh aspect. In a possible design, the chip system further includes a memory, and the memory is configured to store a program and data that are necessary for the apparatus. The chip system may include a chip, or may include a chip and another discrete component.

### BRIEF DESCRIPTION OF DRAWINGS

FIG. 1 is a diagram of a communication system to which embodiments of the present disclosure are applicable;

FIG. 2 is a diagram of an SSB symbol according to an embodiment of the present disclosure;

FIG. 3 is a diagram of a communication method 100 according to an embodiment of the present disclosure;

FIG. 4 is a diagram of different types of synchronization rasters according to an embodiment of the present disclosure;

FIG. 5 is a diagram of different types of synchronization signals according to an embodiment of the present disclosure;

FIG. 6 is a diagram of an association relationship between different TRP types and different types of synchronization rasters according to an embodiment of the present disclosure;

FIG. 7 is a diagram of a communication method 200 according to an embodiment of the present disclosure;

FIG. 8 is a schematic block diagram of a communication apparatus 10 according to an embodiment of the present disclosure;

FIG. 9 is a diagram of another communication apparatus 20 according to an embodiment of the present disclosure; and

FIG. 10 is a diagram of a chip system 30 according to an embodiment of the present disclosure.

### DESCRIPTION OF EMBODIMENTS

The following describes technical solutions of the present disclosure with reference to accompanying drawings.

The technical solutions in embodiments of the present disclosure may be implemented in various communication systems, for example, a 5th generation (5G) system or new radio (NR), a long term evolution (LTE) system, an LTE frequency division duplex (FDD) system, LTE time division duplex (TDD), and the like. The technical solutions provided in the present disclosure may be further applied to a future communication system, for example, a sixth generation mobile communication system. The technical solutions in embodiments of the present disclosure may be further applied to device-to-device (D2D) communication, vehicle-to-everything (V2X) communication, machine-to-machine (M2M) communication, machine-type communication (MTC), an internet of things (IoT) communication system, or another communication system.

For ease of understanding embodiments of the present disclosure, a communication system shown in FIG. 1 is first used as an example to describe in detail a communication system to which embodiments of the present disclosure are applicable.

FIG. 1 is a diagram of a communication system to which embodiments of the present disclosure are applicable.

The communication system includes at least one network device and at least one terminal device. As shown in (a) in FIG. 1, the terminal device 110 is connected to a single network device (for example, a base station) 120, and the terminal device 110, the base station 120, and a core network connected to the base station 120 are in a same standard. For example, the core network is a 5G core network, the base station is correspondingly a 5G base station, and the 5G base station is directly connected to the 5G core network; or the core network is a 6G core network, the base station is a 6G base station, and the 6G base station is directly connected to the 6G core network.

(b) in FIG. 1 shows a dual connectivity (DC) scenario. In this scenario, the terminal device is connected to two network devices at the same time, and standards of the two network devices may be the same or may be different. For example, the core network is a 5G core network, and the terminal is connected to both a 5G base station and a 6G base station, where the 5G base station serves as a primary station, and the 6G base station serves as a secondary station. For another example, the core network is a 6G core network, and the terminal is connected to both a 6G base station and a 5G base station, where the 6G base station serves as a primary station, and the 5G base station serves as a secondary station. For another example, the core network is a 6G core network, and the terminal is connected to two 6G base stations, namely, a primary station and a secondary station are both 6G base stations.

It should be understood that FIG. 1 is merely a diagram. The communication system may further include another network device, for example, may further include a wireless relay device and a wireless backhaul device that are not shown in FIG. 1. A quantity of network devices and a quantity of terminal devices included in the mobile communication system are not limited in embodiments of the present disclosure.

The terminal device in embodiments of the present disclosure may be user equipment, an access terminal, a subscriber unit, a subscriber station, a mobile station, a remote station, a remote terminal, a mobile device, a user terminal, a wireless communication device, a user agent, or a user apparatus. The terminal in embodiments of the present disclosure may be a mobile phone, a tablet computer (pad), a computer having a wireless transceiver function, a virtual reality (VR) terminal, an augmented reality (AR) terminal, a wireless terminal in industrial control, a wireless/T terminal in self-driving, a wireless terminal in remote medical, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal in a 5G network, a terminal in a future evolved network, or the like.

The wearable device may also be referred to as a wearable intelligent device, and is a general name of wearable devices, such as glasses, gloves, watches, clothes, and shoes, that are developed by applying wearable technologies to an intelligent design of daily wear. The wearable device is a portable device that can be directly worn on the body or integrated into clothes or an accessory of a user. The wearable device is not only a hardware device, but also implements a powerful function through software support, data exchange, and cloud interaction. In a broad sense, the wearable intelligent devices include full-featured and large-size devices that can implement complete or partial functions without depending on smartphones, such as smart watches or smart glasses, and devices that focus only on a type of application function and need to work with other devices such as smartphones, such as various smart bands or smart jewelry for monitoring physical symptoms.

In addition, the terminal device may alternatively be a terminal device in an internet of things (IoT) system. A technical feature of the IoT is to connect an object to a network by using a communication technology, to implement an intelligent network of human-machine interconnection and thing-thing interconnection. A specific form of the terminal device is not limited in the present disclosure.

It should be understood that, in embodiments of the present disclosure, the terminal device may be an apparatus configured to implement a function of the terminal device, or may be an apparatus, for example, a chip system, that can support the terminal device in implementing the function. The apparatus may be mounted in the terminal. In embodiments of the present disclosure, the chip system may include a chip, or may include a chip and another discrete component.

The network device in embodiments of the present disclosure may be any device having a wireless transceiver function. The device includes but is not limited to an evolved NodeB (eNB), a home base station (for example, a home evolved NodeB, or a home NodeB, HNB), a baseband unit (BBU), an access point (AP) in a wireless fidelity (Wi-Fi) system, a wireless relay node, a wireless backhaul node, a transmission point (TP) or a transmission reception point (TRP), or the like, or may be a next generation NodeB (gNB) in a 5th generation (5G) like new radio (NR) wireless communication system, a transmission point (TRP or TP), one or a group of (including a plurality of antenna panels) antenna panels of a base station in a 5G system, or a network node that forms a gNB or a transmission point, for example, a baseband unit (BBU) or a distributed unit (DU), or the like.

It should be understood that, in embodiments of the present disclosure, the network device may be an apparatus configured to implement a function of the network device, or may be an apparatus, for example, a chip system, that can support the network device in implementing the function. The apparatus may be mounted in the network device.

The technical solutions in embodiments of the present disclosure may be applied to service scenarios such as backscatter communication in an NR communication system and passive internet of things communication, and various communication systems, for example, an LTE frequency division duplex (FDD) system, LTE time division duplex (TDD), a 5G system, vehicle-to-everything (vehicle-to-X, V2X), where V2X may include vehicle-to-network (V2N), vehicle-to-vehicle (V2V), vehicle-to-infrastructure (V2I), vehicle-to-pedestrian (V2P), and the like, long term evolution-vehicle (LTE-V), an internet of vehicles, machine-type communication (MTC), an internet of things (IoT), long term evolution-machine (LTE-M), machine-to-machine (M2M), device-to-device (D2D), or a future evolved communication system, for example, a 6th generation (6G) system.

It should be understood that a cell refers to a coverage area in a wireless communication system, and one or more base stations are responsible for providing wireless signal coverage and a communication service. Based on context in which the term “cell” is used, the term “cell” may refer to a coverage area of a NodeB (NB) and/or a NodeB subsystem serving the coverage area. In an NR system, the term “cell” and a next generation NodeB (gNB), an NR BS, a 5G NB, an access point (AP), or a transmission reception point (TRP) may be interchangeable.

To satisfy the growing demand of people for traffic, wireless networks are being rapidly constructed. As a network scale increases, network energy consumption increases continuously, and costs of operators are significantly increased due to electricity fees. The following are main reasons for an increase in energy consumption:
(1) In the 5G and 6G eras, with large-scale commercial use of active antenna units (AAU), a quantity of antennas on a base station side increases significantly. Compared with the 3G and 4G eras, energy consumption of base stations increases exponentially.
(2) In the 5G and 6G eras, more transmission bandwidths are required due to the demand for higher data rates and larger traffic, which increases energy consumption on the base station side accordingly.
(3) Use of millimeter waves and terahertz leads to dense site deployment. Adding sites means increasing energy consumption.

In addition to the increase in energy consumption leading to a great increase in the costs of the operators, energy saving and emission reduction also represent a social responsibility for the operators, and regulatory requirements of government departments must be met. Therefore, regardless of research in a current wireless communication system or research in a next-generation wireless communication system, optimization research is continuously needed for energy saving on a network side.

In current networks, different vendors and operators all use various energy saving means. An existing overall 5G energy saving technical system includes device-level, site-level, and network-level energy saving. For device-level energy saving, hardware energy saving is conducted mainly from a perspective of component and hardware designs. For site-level energy saving, software energy saving is conducted mainly from aspects of symbol power saving, channel shutdown, carrier shutdown, and deep dormancy. For network-level energy saving, intelligent energy saving is conducted by a terminal from a perspective of multi-network coordination.

In addition, energy consumption reduction on the network side is continuously researched during NR system evolution. For example, in 3GPP Rel-18, a corresponding study item (SI) and a corresponding work item (WI) for a network energy saving feature are separately initiated, to support flexible antenna unit shutdown, flexible transmit power adjustment, and discontinuous transmission on the base station side that are on the network side. Considering existing terminals on the live network, a mechanism for avoiding access of the existing terminals to cells that support the new energy saving feature is also studied.

In addition, in a design of a next-generation communication system, the network side supports operating modes with different network energy consumption. Two operating modes are used as an example, and may be respectively referred to as an energy saving mode and a transmission enhancement mode. In different operating modes, transmission resources (including a time domain resource, a frequency domain resource, a space domain resource, and a power domain resource) used by the network side, supported functions (for example, whether small packet transmission is supported), and related procedures (for example, an access procedure) may be different.

The following describes terms in embodiments of the present disclosure.

### 1. Synchronization Raster

After the terminal is powered on, a non-access stratum (NAS) first needs to select a proper public land mobile network (PLMN). Then, the NAS indicates a radio resource control (RRC) layer to perform cell selection and reselection based on the determined PLMN. The cell selection may be phased into four processes: frequency scanning, cell searching, system information parsing, and camping.

The frequency scanning means searching, based on a standard and a frequency band supported by the terminal device, for a cell covered in a network environment in which the mobile phone is located and power of the cell. The cell searching is a process of capturing a cell with best coverage in the network environment based on a frequency scanning result after the frequency scanning is completed, performing frame synchronization and slot synchronization on the cell, and obtaining a physical cell ID. The system information parsing and the cell camping are a process of reading cell system information after the cell searching is completed and measuring cell signal strength and signal quality, and determining whether the cell meets a camping condition.

It may be understood that the frequency scanning procedure is performed based on a frequency band supported by a capability of the terminal device only during initial cell selection. In other words, if frequency information is stored before the cell selection (for example, the cell reselection), the frequency scanning procedure is skipped and the cell searching is performed directly.

Because a maximum cell bandwidth that can be supported in NR is very wide, a proper granularity needs to be considered during the frequency scanning, to avoid a very slow access speed of the UE and high power consumption. To enable the terminal to more quickly find a cell (the following uses a synchronization signal and PBCH block (SSB) as an example for description), a center frequency and an interval of the SSB are specified in the NR, and are referred to as a synchronization raster. Formulas for calculating center frequencies of the SSB in different frequency bands are specifically shown in Table 1.

TABLE 1
SSB frequency domain position and GSCN calculation

| | SSB frequency domain | Global | Range of |
|---|---|---|---|
| Range of frequency | position (SS block | synchronization | GSCNs |
| domain (Range of | frequency position | channel number | (Range of |
| frequencies (MHz)) | SS_{REF}) | (GSCN) | GSCN) |
| 0-3000 | N*1200 kHz + M*50 kHz, | 3N + (M − 3)/2 | 2-7498 |
| | N = 1:2499, M ∈ {1, 3, 5} | | |
| | (Note) | | |
| 3000-24250 | 3000 MHz + N*1.44 MHz, | 7499 + N | 7499-22255 |
| | N = 0:14756 | | |
| 24250-100000 | 24250.08 MHz + N*17.28 | 22256 + N | 22256-26639 |
| | MHz, N = 0:4383 | | |

A default value of an operating band of an SCS spacing channel raster is only supported to be M=3.

In Table 1, SS_{REF} represents the center frequency of the SS Block, and the global synchronization channel number (GSCN) is used to mark a channel number of the SSB.

It may be understood that the SSB is placed based on the synchronization raster. The terminal device performs frequency scanning based on the synchronization raster. In the protocol TS 38.101, subcarrier spacings (SCS), multiplexing modes, and ranges and intervals of GSCNs of corresponding SSBs in different bands are defined. For details, refer to the following Table 2.

TABLE 2
Applicable SS raster entry for each operating band

| NR operating | Synchronization | Synchronization | |
|---|---|---|---|
| band | signal block | signal block | Range of GSCNs |
| (NR operating | subcarrier spacing | pattern (SS | (First-<Step |
| band) | (SS Block SCS) | Block pattern¹) | size>-Last) |
| n1 | 15 kHz | Case A | 5279-<1>-5419 |
| n2 | 15 kHz | Case A | 4829-<1>-4969 |
| n3 | 15 kHz | Case A | 4517-<1>-4693 |
| n5 | 15 kHz | Case A | 2177-<1>-2230 |
| | 30 kHz | Case B | 2183-<1>-2224 |
| n7 | 15 kHz | Case A | 6554-<1>-6718 |
| n8 | 15 kHz | Case A | 2318-<1>-2395 |
| n12 | 15 kHz | Case A | 1828-<1>-1858 |
| n14 | 15 kHz | Case A | 1901-<1>-1915 |
| n18 | 15 kHz | Case A | 2156-<1>-2182 |
| n20 | 15 kHz | Case A | 1982-<1>-2047 |
| n25 | 15 kHz | Case A | 4829-<1>-4981 |
| n26 | 15 kHz | Case A | 2153-<1>-2230 |
| n28 | 15 kHz | Case A | 1901-<1>-2002 |
| n29 | 15 kHz | Case A | 1798-<1>-1813 |
| n30 | 15 kHz | Case A | 5879-<1>-5893 |
| n34 | 15 kHz | Case A | 5030-<1>-5056 |
| n38 | 15 kHz | Case A | NOTE 2 |
| | 30 kHz | Case C | 6437-<1>-6538 |
| n39 | 15 kHz | Case A | 4706-<1>-4795 |
| n40 | 30 kHz | Case C | 5762-<1>-5989 |
| n41 | 15 kHz | Case A | 6246-<3>-6717 |
| | 30 kHz | Case C | 6252-<3>-6714 |
| n48 | 30 kHz | Case C | 7884-<1>-7982 |
| n50 | 30 kHz | Case C | 3590-<1>-3781 |
| n51 | 15 kHz | Case A | 3572-<1>-3574 |
| n53 | 15 kHz | Case A | 6215-<1>-6232 |
| n65 | 15 kHz | Case A | 5279-<1>-5494 |
| n66 | 15 kHz | Case A | 5279-<1>-5494 |
| | 30 kHz | Case B | 5285-<1>-5488 |
| n70 | 15 kHz | Case A | 4993-<1>-5044 |
| n71 | 15 kHz | Case A | 1547-<1>-1624 |
| n74 | 15 kHz | Case A | 3692-<1>-3790 |
| n75 | 15 kHz | Case A | 3584-<1>-3787 |
| n76 | 15 kHz | Case A | 3572-<1>-3574 |
| n77 | 30 kHz | Case C | 7711-<1>-8329 |
| n78 | 30 kHz | Case C | 7711-<1>-8051 |
| n79 | 30 kHz | Case C | 8480-<16>-8880 |
| n90 | 15 kHz | Case A | 6246-<1>-6717 |
| | 30 kHz | Case C | 6252-<1>-6714 |
| n91 | 15 kHz | Case A | 3572-<1>-3574 |
| n92 | 15 kHz | Case A | 3584-<1>-3787 |
| n93 | 15 kHz | Case A | 3572-<1>-3574 |
| n94 | 15 kHz | Case A | 3584-<1>-3787 |

The SSB pattern is defined in clause 4.1 of TS 38.213 [8]. The applicable SS raster entry is GSCN={6432, 6443, 6457, 6468, 6479, 6493, 6507, 6518, 6532, 6543}.

However, when the network side has different operating modes (or operating states), a specific type of terminal device (for example, a terminal device in an NB-IoT (Narrowband Internet of Things) communication system) in a specific standard cannot quickly obtain an operating mode of the cell in the foregoing manner in the frequency scanning phase.

### 2. Synchronization Signal and Physical Broadcast Channel Block (Synchronization Signal and PBCH Block, SSB)

Synchronization signal (SS): The synchronization signal is used to implement time-frequency synchronization between the terminal and the network side and to detect a physical cell identity (ID). The synchronization signal includes a primary synchronization signal (PSS) and/or a secondary synchronization signal (SSS). The PSS is used by the terminal device to perform time-frequency synchronization and cell detection. The SSS is used to transmit the physical cell identity ID. Alternatively, the PSS and the SSS may be combined to implement the foregoing functions.

Physical broadcast channel (PBCH): The physical broadcast channel is used to transmit primary system information, for example, a small amount of important information and an obtaining method of other system information.

Synchronization signal and physical broadcast channel block (synchronization signal/PBCH block, SSB): The synchronization signal and physical broadcast channel block is referred to as a synchronization signal block, includes a synchronization signal SS and/or a PBCH, and is used to implement time synchronization, detect the physical cell identity (ID), obtain the primary system information, and the like.

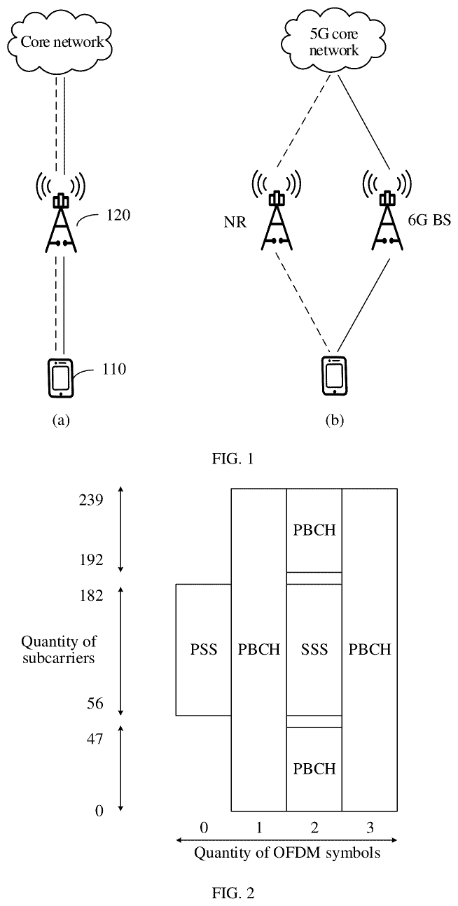

FIG. 2 is a diagram of content included in an SSB symbol according to an embodiment of the present disclosure. As shown in FIG. 2, an SSB bandwidth is 20 resource blocks (RB), including 240 subcarriers (subcarrier). A 1st symbol carries a PSS, and includes 127 subcarriers, that is, a sequence length of the PSS is 127, and the PSS occupies only a middle part of an SSB frequency domain, and no other data or control information is sent on two sides. 2nd and 4th symbols are broadcast channels (PBCH), and mainly carry system information. A 3rd symbol carries both PBCHs and an SSS, where the SSS and the PSS have a same sequence length of 127, and both occupy 127 resource elements (RE) in the middle of the SSB frequency domain. 48 REs on two sides of the SSS are used to send the PBCHs respectively, and there are an interval of 8 REs and an interval of 9 REs between the SSS and the PBCHs. To be specific, the PSS and the SSS occupy one orthogonal frequency division multiplexing (OFDM) symbol in time domain, and occupy 127 REs in frequency domain, that is, occupy 56^{th} to 182^{nd} REs. The PSS occupies a symbol 0 in the SSB, and the SSS occupies a symbol 2 in the SSB; and the PBCH occupies a symbol 1 and a symbol 3 in the SSB, and occupies a part of REs in the symbol 2.

One function of the SSB is cell access. To be specific, the terminal device may receive MIB information by using the SSB, to obtain a SIBI associated with the SSB, and access a cell. Because the SSB includes a PSS, an SSS, a PBCH, and a demodulation reference signal (DMRS), the SSB may also be used by the terminal device to perform time-frequency tracking (or referred to as time-frequency synchronization), beam management, radio resource management (RRM) measurement, radio link monitoring (RLM) measurement, channel state information (CSI) measurement, and the like.

The SSB includes the synchronization signals and the physical broadcast channel PBCH. The physical broadcast channel is used to carry a master information block (MIB) and indicate a retrieval position of a system information block 1 (SIB1). The SIB1 includes system information required for the terminal to access a network, and the SIB1 may also be referred to as remaining minimum system information (RMSI).

A sending periodicity of the SSB may be indicated by using a SIB, and configurable periodicities include 5 ms, 10 ms, 20 ms, 40 ms, 80 ms, and 160 ms. During initial cell searching, a default periodicity of the SSB is 20 ms.

In consideration of excessively high network energy consumption caused due to unnecessary energy consumption that arises when a network side still needs to periodically wake up and send a periodic SSB even if there is no service, configuring a longer sending periodicity of the SSB or simplifying a structure of the SSB is also a feasible manner of implementing network energy saving. An SSB with a simplified structure may include only a PSS, or include only a PSS and an SSS, or include a PSS, an SSS, and a part of a PBCH. In this manner, a periodic SSB occupies lower time domain overheads, and correspondingly, shutdown time on the network side is longer, and network overheads are lower. However, the terminal device cannot determine an operating mode of the cell after receiving the SSB with the simplified structure.

In view of this, embodiments of the present disclosure provide a method and an apparatus for quickly indicating an operating mode of a cell, so that when a network side supports at least two operating modes, a terminal can quickly obtain an operating mode and an access manner of a current cell after being powered on. The operating modes have different energy consumption, and are associated with different transmission resources, functions, hardware, and the like.

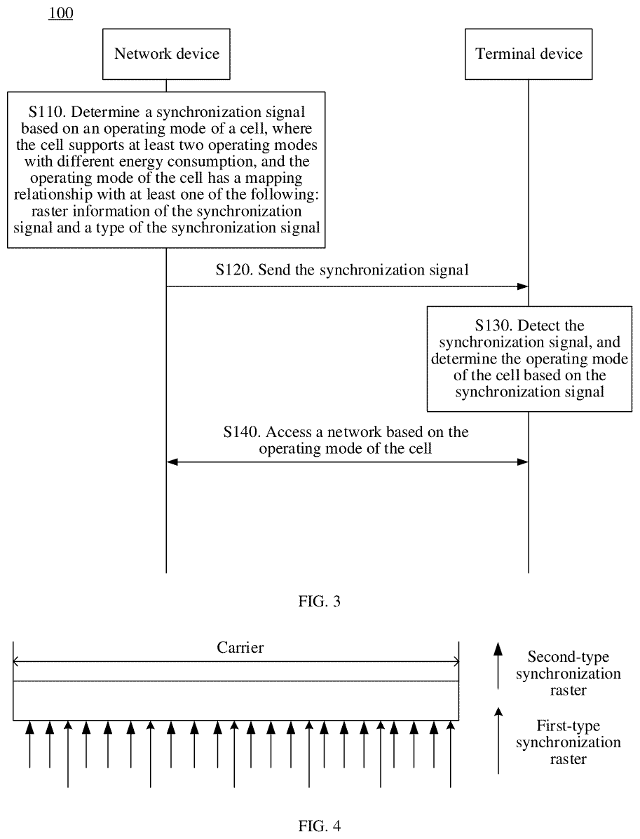

FIG. 3 is a diagram of a communication method 100 according to an embodiment of the present disclosure. As shown in FIG. 3, the method 100 includes the following steps.

S110. A network device determines a synchronization signal based on an operating mode of a cell, where the cell supports at least two operating modes with different energy consumption, and the operating mode of the cell has a mapping relationship with at least one of the following: raster information of the synchronization signal and a type of the synchronization signal.

It should be understood that a specific quantity of operating modes supported by the cell is not limited in this embodiment of the present disclosure.

In an example, the cell supports two operating modes: an energy saving mode and a transmission enhancement mode, and the two operating modes have different energy consumption.

In another example, the cell supports four operating modes: a first energy saving mode, a second energy saving mode, a first transmission enhancement mode, and a second transmission enhancement mode, and the four operating modes have different energy consumption.

It should be understood that names of the foregoing operating modes are merely an example, and do not constitute any limitation on a name of a future operating mode.

It should be noted that, in this embodiment of the present disclosure, the raster information of the synchronization signal and a type of a synchronization raster may be interchangeable.

In a possible implementation, the present disclosure provides at least two different types of synchronization rasters, and each of different types of synchronization rasters is associated with an operating mode of the cell. The following uses two types of synchronization rasters as an example for description.

For example, N operating modes and N types of synchronization rasters are defined, and the N operating modes are in one-to-one correspondence with the N types of synchronization rasters, where a first-type synchronization raster is associated with a first operating mode, and a second-type synchronization raster is associated with a second operating mode.

It should be understood that, in this embodiment of the present disclosure, a difference between different types of synchronization rasters may include one or more of the following: Different types of synchronization rasters have different frequency domain offsets; different types of synchronization rasters have different frequency domain intervals, also referred to as frequency domain granularities; and different types of synchronization rasters define different GSCN calculation manners. The following uses the two types of synchronization rasters as an example for description.

By way of example but not limitation, the foregoing three parameters of the first-type synchronization raster and the second-type synchronization raster are different. Based on this, when SS positions on the first-type synchronization raster and the second-type synchronization raster are calculated, frequency domain granularities (frequency domain intervals) and frequency domain offset values associated with the first-type synchronization raster and the second-type synchronization raster are different. An example is shown in Table 3 below.

TABLE 3
Calculation parameter of frequency domain positions
on different types of synchronization rasters

| Range of | | Granularity (Granularity) | | | | Offset Value (Offset) | | | |
|---|---|---|---|---|---|---|---|---|---|
| frequency domain | | First | | Second | | First | | Second | |
| (Frequency | | operating | | operating | | operating | | operating | |
| Range) | | mode | | mode | | mode | | mode | |
| 0-3000 | MHz | 3600 | kHZ | 1200 | kHz | 75 | kHz | 50 | kHz |
| 3000-24250 | MHz | 4.32 | MHz | 1.44 | MHz | 3000.5 | MHz | 3000 | MHz |
| 24250-100000 | MHz | 51.84 | MHz | 17.28 | MHz | 24250.5 | MHz | 24250.08 | MHz |

Based on Table 3, using a frequency range of 0 to 3000 MHz as an example, when the cell operates in the second operating mode, the formula in Table 1 can be reused as a calculation formula for a center frequency domain position of an SSB sent by the cell, that is, N*1200 kHz+M*50 kHz, N=1:2499, M∈{1, 3, 5}. When the network device operates in the first operating mode, a different granularity and a different offset value need to be used for a frequency domain position of an SSB sent by the network device, that is, N*3600 kHz+M*75 kHz, N=1:839, M ∈{1, 3, 5}. It should be understood that when the granularity is increased, to obtain an SSB at an approximate frequency domain position, a value of M is adaptively increased in this embodiment of the present disclosure. However, a specific value of N in a first operating mode is not limited. For example, N=1:839 is merely an example.

In addition, in this implementation, different GSCN calculation formulas are further defined for the two different types of synchronization rasters. For ease of understanding, still using the frequency range of 0 to 3000 MHz as an example, a GSCN calculation formula in Table 1 is 3N+(M−3)/2, where values of N and M are related to the frequency domain position of the SSB, and are respectively N=1:2499 and M∈{1, 3, 5}. In this case, when the cell operates in the second operating mode, the formula in Table 1 can be reused as the GSCN calculation formula. When the cell operates in the first operating mode, the GSCN calculation manner is: 3N+(M−3)/2+P, where a value of P is a protocol-predefined value, for example, 10000. It should be understood that, in this embodiment of the present disclosure, P is introduced to distinguish GSCNs of different types of synchronization rasters. A specific value of P in the GSCN calculation formula in the first operating mode is merely an example. This is not limited in the present disclosure.

It should be understood that, when the cell switches between different operating modes, a sending or receiving position of a synchronization signal of the cell also changes accordingly. For example, when the cell switches from the first operating mode to the second operating mode, a potential sending or receiving position of the synchronization signal of the cell is also switched from the first-type synchronization raster to the second-type synchronization raster.

It should be understood that types of synchronization signals (or associated synchronization signals) placed on synchronization rasters of different raster types are not limited in the present disclosure. For example, types of synchronization signals associated with different synchronization rasters can be different. The difference can be reflected in a sequence type (for example, a ZC (Zadoff-Chu) sequence or an m sequence), a sequence length (for example, a long sequence and a short sequence), and the like.

It should be understood that the network device can explicitly indicate the operating mode of the cell by using different types of synchronization rasters, or the network device can implicitly indicate the operating mode of the cell by using different types of synchronization rasters. This is not limited in this embodiment of the present disclosure. A specific manner in which the network device implicitly indicates the operating mode of the cell by using different types of synchronization rasters is described in detail below.

In another possible implementation, this embodiment of the present disclosure provides at least two different types of synchronization signals, and each of the different types of synchronization signals is associated with an operating mode of the cell. The different types of synchronization signals have a same center frequency.

It should be understood that a difference between different types of synchronization signals in this embodiment of the present disclosure may include one or more of the following: different sequence lengths and different signal content.

Specifically, the foregoing different signal content may be understood as that the synchronization signal includes one or more of a primary synchronization signal PSS, a secondary synchronization signal SSS, a master information block MIB, and a timing synchronization signal. The timing synchronization signal is a timing relationship between receiving a synchronization signal and a wake-up signal.

In a possible implementation, to improve frequency scanning accuracy of synchronization signals with different sequence lengths, a sequence with a short sequence length (referred to as a short sequence below) can be a middlemost part intercepted from a sequence with a long sequence length (referred to as a long sequence below). For example, the length of the short sequence is N, the length of the long sequence is M, and the short sequence corresponds to N middlemost bits in the long sequence M.

It should be understood that the network device can explicitly indicate the operating mode of the cell by using different types of synchronization signals, or the network device can implicitly indicate the operating mode of the cell by using different types of synchronization signals. This is not limited in this embodiment of the present disclosure. A specific manner in which the network device implicitly indicates the operating mode of the cell by using different types of synchronization signals is described in detail below.

S120. The network device sends the synchronization signal.

In a possible implementation, the network device sends the synchronization signal on a synchronization raster corresponding to the operating mode of the cell.

In another possible implementation, the network device sends a synchronization signal of a synchronization signal type corresponding to the operating mode of the cell.

S130. A terminal device detects the synchronization signal, and determines the operating mode of the cell based on the synchronization signal.

Specifically, the terminal device determines the operating mode of the cell based on the first-type synchronization raster or the type of the synchronization signal.

In a possible implementation, the terminal device detects the synchronization signal on a synchronization raster, and determines an operating mode of the cell based on a type of the synchronization raster.

As shown in FIG. 4, two types of arrows respectively identify two types of synchronization rasters. The first-type synchronization raster is associated with the first operating mode, and the second-type synchronization raster is associated with the second operating mode. When detecting the synchronization signal on the first-type synchronization raster, the terminal device can determine that the cell operates in the first operating mode. When detecting the synchronization signal on the second-type synchronization raster, the terminal device can determine that the cell operates in the second operating mode. Further, after frequency scanning is completed, the terminal device can camp on the cell based on the obtained operating mode of the cell, and a function, a resource, and the like that are related to the operating mode of the cell.

In another possible implementation, the terminal device detects the synchronization signal, and determines an operating mode of the cell based on the type of the synchronization signal.

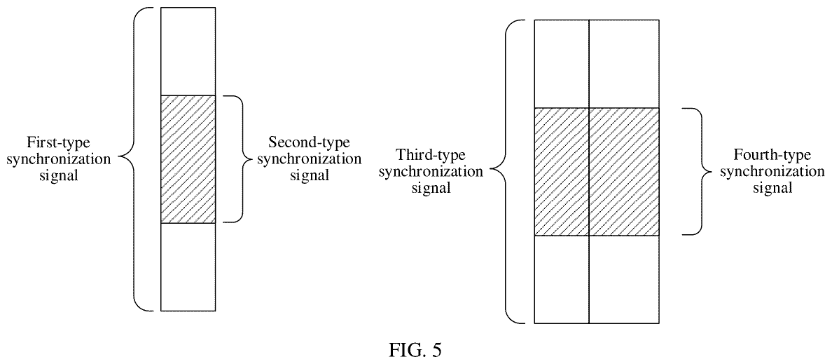

As shown in FIG. 5, a first-type synchronization signal and a third-type synchronization signal are associated with the first operating mode, and a second-type synchronization signal and a fourth-type synchronization signal are associated with the second operating mode. After detecting the synchronization signal on a synchronization raster, the terminal device can determine the type of the synchronization signal in a system information parsing process, to determine the operating mode of the cell corresponding to the SSB. Further, the terminal device can camp on the cell based on the obtained operating mode of the cell, and a function, a resource, and the like that are related to the operating mode of the cell.

S140. The terminal device accesses a network based on the operating mode of the cell.

Specifically, after determining the operating mode of the cell in step S130, the terminal device can access the network based on the operating mode of the cell. A specific manner of accessing the network is described in detail below.

Optionally, in this embodiment of the present disclosure, operating modes of the cell may be not in one-to-one correspondence with types of the synchronization raster. In other words, one type of synchronization raster can correspond to a plurality of operating modes of the cell.

Specifically, in this embodiment of the present disclosure, X operating modes and Y types of synchronization rasters are defined. There is a correspondence between the X operating modes and the Y types of synchronization rasters, and there is a correspondence between at least two operating modes in the X operating modes and one type of synchronization raster in the Y types of synchronization rasters, where X>Y>2.

By way of example but not limitation, in this embodiment of the present disclosure, six operating modes and two types of synchronization rasters are defined. A first operating mode, a third operating mode, and a fifth operating mode are associated with a first-type synchronization raster, and a second operating mode, a fourth operating mode, and a sixth operating mode are associated with a second-type synchronization raster. One or more operating parameters (for example, an access procedure) are reused for the operating modes corresponding to one type of synchronization raster.

Optionally, in this embodiment of the present disclosure, operating modes of the cell may be not in one-to-one correspondence with types of the synchronization signal. In other words, one type of synchronization signal can correspond to a plurality of operating modes of the cell. Specifically, in this embodiment of the present disclosure, A operating modes and B types of synchronization signals are defined. There is a correspondence between the A operating modes and the B types of synchronization signals, and there is a correspondence between at least two operating modes in the A operating modes and one type of synchronization signal in the B types of synchronization signals, where A>B≥2.

By way of example but not limitation, in this embodiment of the present disclosure, five operating modes and three types of synchronization signals are defined. A first operating mode and a third operating mode are associated with a first-type synchronization signal, a second operating mode is associated with a second-type synchronization signal, and a fourth operating mode and a fifth operating mode are associated with a third-type synchronization signal. One or more operating parameters (for example, an access procedure) are reused for the operating modes corresponding to one type of synchronization signal.

In the method 100, the network device can determine a first type, that is, the type of the synchronization raster and/or the type of the synchronization signal, based on the operating mode of the cell, and send the synchronization signal based on the first type. Correspondingly, after receiving the synchronization signal, the terminal device can determine the operating mode of the cell based on the first type, and further determine an access procedure. A specific association manner between the first type and the operating mode of the cell is specifically described below.

First, an application procedure 200 of the method 100 is specifically described. In the application procedure 200, a terminal device determines an operating mode of a cell based on a type of a synchronization raster. The method 200 includes the following steps.

S210. A network device determines, based on an operating mode of a cell, a type of a synchronization raster in which a synchronization signal of the cell is located, where the cell supports at least two operating modes with different energy consumption.

In a possible implementation, the network device determines, based on an association relationship #A (an example of a first association relationship) and the operating mode of the cell, the type of the synchronization raster in which the synchronization signal of the cell is located. The association relationship #A is an association relationship between the type of the synchronization raster and the operating mode of the cell. For example, in the association relationship #A, when the operating mode of the cell is a first operating mode, a corresponding synchronization raster is a first-type synchronization raster; or when the operating mode of the cell is a second operating mode, a corresponding synchronization raster is a second-type synchronization raster. In this case, the cell operating in the first operating mode sends the synchronization signal on the first-type synchronization raster.

It should be understood that with different energy consumption, different operating modes of the cell should have different operating parameters. The operating parameter of the cell includes one or more of the following:
a minimum system information obtaining manner of the cell, where for example, minimum system information is actively broadcast by a network side, or is sent under triggering of a request of a terminal device;
an access type of the cell, where for example, an access procedure is based on a preamble sequence, or an access procedure is based on a wake-up signal sent by the terminal device;
a common signal periodicity of the cell, where for example, the common signal periodicity is 5 ms, or the common signal periodicity is 20 ms; common signals of the cell include a primary synchronization signal, a secondary synchronization signal, a physical broadcast channel, a system information block 1 (SIB1), and the like; and it should be understood that the common signal periodicity of the cell may be periodicities of the one or more common signals;
a transmission resource of the cell, for example, a time domain position of the transmission resource of the cell, a frequency domain position of the transmission resource, a space domain resource of the transmission resource, transmit power of the cell, a bandwidth of the cell, and the like;
a feature and a function supported by the cell, for example, whether the cell supports small packet (small data) transmission, whether the cell supports a multicast service, and the like; and
a hardware resource of the cell, for example, a quantity of antennas supported by the cell, quantization precision of digital-to-analog conversion/analog-to-digital conversion, and the like.

It should be understood that a specific manner in which the network device determines the association relationship #A is not limited in the present disclosure.

For example, the association relationship #A is protocol-predefined.

For example, the association relationship #A is determined by the network device.

S220. The network device sends the synchronization signal based on the type of the synchronization raster.

Specifically, the network device sends the synchronization signal on a synchronization raster of the type based on the type of the synchronization raster determined in step S210.

It should be understood that, in this embodiment of the present disclosure, types of synchronization signals sent on different types of synchronization rasters are not limited. For example, a first-type synchronization signal is sent on a first-type synchronization raster, and a second-type synchronization signal is sent on a second-type synchronization raster, where the first-type synchronization signal and the second-type synchronization signal have different sequence lengths.

S230. The terminal device detects the synchronization signal, and determines the operating mode of the cell based on the type of the synchronization raster.

In a possible manner, the terminal device determines the operating mode of the cell based on the type of the synchronization raster and the association relationship #A. For a manner in which the terminal device determines the type of the synchronization raster, refer to S130. Details are not described herein again.

It should be understood that a specific manner in which the terminal device determines the association relationship #A is not limited in the present disclosure.

For example, the association relationship #A is protocol-predefined.

For example, before receiving the synchronization signal, the terminal device receives system information broadcast by the network device, where the system information includes the association relationship #A.

S240. The terminal device accesses a network based on the operating mode of the cell.

In a possible implementation, the terminal device determines, based on the determined operating mode of the cell, an operating parameter corresponding to the operating mode of the cell, to access the network.

It should be understood that a specific manner in which the terminal device determines the operating parameter of each operating mode is not limited in the present disclosure.

For example, a specific operating parameter of each operating mode is protocol-predefined.

For example, before receiving the synchronization signal, the terminal device receives system information broadcast by the network device, where the system information includes the specific operating parameter of each operating mode.

In the method 200, the type of the synchronization raster is associated with the operating mode of the cell, so that the terminal device can quickly determine the operating mode of the cell based on a frequency scanning result, and then access the network based on the operating mode of the cell. The following method specifically describes a method for associating a type of a synchronization signal with an operating mode of a cell.

The following specifically describes another application procedure 300 of the method 100. In the application procedure 300, a terminal device determines the operating mode of the cell based on the type of the synchronization signal. The method 300 includes the following steps.

S310. A network device determines, based on an operating mode of a cell, a type of a synchronization signal of the cell, where the cell supports at least two operating modes with different energy consumption.

In a possible implementation, the network device determines, based on an association relationship #C (another example of a first association relationship) and the operating mode of the cell, the type of the synchronization signal of the cell. The association relationship #C is an association relationship between the type of the synchronization signal and the operating mode of the cell. For example, in the association relationship #C, when the operating mode of the cell is a first operating mode, a corresponding synchronization signal is a first-type synchronization signal; or when the operating mode of the cell is a second operating mode, a corresponding synchronization signal is a second-type synchronization signal. In this case, the cell operating in the first operating mode sends the first-type synchronization signal.

It should be understood that, for descriptions of an operating parameter of the operating mode of the cell, refer to related descriptions in step S210. Details are not described herein again.

It should be understood that, for descriptions of a specific manner in which the network device determines the association relationship #C, refer to related descriptions in step S210. Details are not described herein again.

S320. The network device sends the synchronization signal based on the type of the synchronization signal. For a specific manner, refer to step S220. Details are not described herein again.

S330. A terminal device detects the synchronization signal, and determines the operating mode of the cell based on the type of the synchronization signal.

In a possible implementation, the terminal device determines the operating mode of the cell based on the type of the synchronization signal and the association relationship #C. For a manner in which the terminal device determines the type of the synchronization signal, refer to S130. Details are not described herein again.

It should be understood that, for descriptions of a specific manner in which the terminal device determines the association relationship #C, refer to related descriptions in step S210. Details are not described herein again.

S340. The terminal device accesses a network based on the operating mode of the cell. For a specific manner, refer to S240. Details are not described herein again.

In the method 300, the type of the synchronization signal is associated with the operating mode of the cell, so that the terminal device can quickly determine the operating mode of the cell based on the type of the synchronization signal in an information parsing phase, and then access the network based on the operating mode of the cell. The following method specifically describes a method for associating a type of a synchronization raster with a TRP type.

It should be understood that there are different types of transmission reception points (TRPs) in wireless communication. For example, the different types of TRPs include a terrestrial cellular (TN), a non-terrestrial network (NTN), and the like. In addition, different TRP types have different delays, frequency offsets, and the like, and also have different access procedures and parameters. Therefore, after a terminal device is powered on, how to quickly determine a TRP type and access a network in a scenario in which different types of TRPs are synchronously deployed is an urgent problem to be resolved.

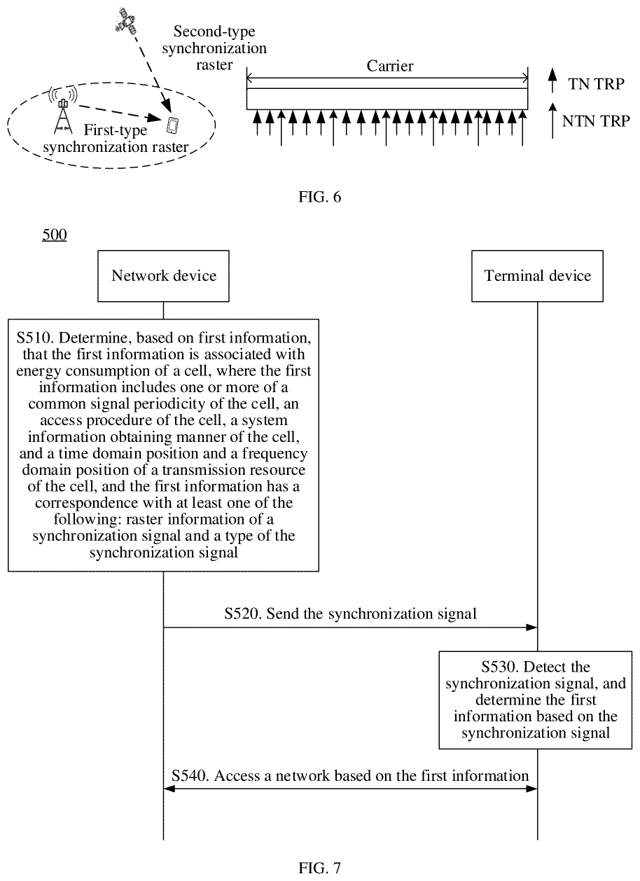

Optionally, in the method 100, different types of synchronization rasters can be further associated with TRP types. By way of example but not limitation, as shown in FIG. 6, a first-type synchronization raster is associated with a TN TRP, and a second-type synchronization raster is associated with an NTN TRP. Specifically, the TN TRP places an SSB on the first-type synchronization raster, and the NTN TRP places an SSB on the second-type synchronization raster.

Correspondingly, after obtaining the SSB from the first-type synchronization raster, the terminal device can determine that the TRP is the TN TRP, to perform random access in a subsequent access procedure based on an access procedure and an access parameter that correspond to the TN TRP. After obtaining the SSB from the second-type synchronization raster, the terminal device can determine that the TRP is the NTN TRP, to perform random access in a subsequent access procedure based on an access procedure and an access parameter that correspond to the NTN TRP.

The following describes in detail a method for determining a TRP type by a terminal device.

S410. A network device determines, based on a TRP type, a type of a synchronization raster in which a synchronization signal of a cell is located.

Specifically, the network device determines, based on the TRP type and an association relationship #E, the type of the synchronization raster in which the synchronization signal is located. The association relationship #E is an association relationship between the type of the synchronization raster and the TRP type. For example, in the association relationship #E, a first-type synchronization raster is associated with a TN TRP, and a second-type synchronization raster is associated with an NTN TRP. When the network device is the TN TRP, the network device determines that the synchronization signal needs to be sent on the first-type synchronization raster.

Optionally, the TRP type can be replaced with a base station type or a cell type. In other words, a terminal device can determine the base station type or the cell type based on raster information of the synchronization signal.

It should be understood that a specific manner in which the network device determines the association relationship #E is not limited in the present disclosure.

For example, the association relationship #E is protocol-predefined.

For example, the association relationship #E is determined by the network device.

S420. The network device sends the synchronization signal based on the type of the synchronization raster.

Specifically, the network device sends the synchronization signal on a synchronization raster of the type based on the type of the synchronization raster determined in step S410.

It should be understood that, in this embodiment of the present disclosure, types of synchronization signals sent on different types of synchronization rasters are not limited. For example, a first-type synchronization signal is sent on the first-type synchronization raster, and a second-type synchronization signal is sent on the second-type synchronization raster, where the first-type synchronization signal and the second-type synchronization signal have different sequence lengths.

S430. The terminal device detects the synchronization signal, and determines the TRP type based on the type of the synchronization raster.

Specifically, the terminal device determines the TRP type based on the type of the synchronization raster and the association relationship #E. By way of example but not limitation, after obtaining the synchronization signal on the first-type synchronization raster, the terminal device can determine, based on the association relationship #E, that the TRP type is the TN TRP. For a manner in which the terminal device determines the type of the synchronization raster, refer to S130. Details are not described herein again.

It should be understood that a specific manner in which the terminal device determines the association relationship #E is not limited in the present disclosure.

For example, the association relationship #E is protocol-predefined.

For example, before receiving the synchronization signal, the terminal device receives system information broadcast by the network device, where the system information includes the association relationship #E.

S440. The terminal device accesses a network based on the TRP type.

Specifically, the terminal device accesses the network based on an access procedure and an access parameter that correspond to the TRP type.

It should be understood that a specific manner in which the terminal device determines the access procedure and the access parameter that correspond to each TRP type is not limited in the present disclosure.

For example, the access procedure and the access parameter that correspond to each TRP type are protocol-predefined.

For example, before receiving the synchronization signal, the terminal device receives system information broadcast by the network device, where the system information includes the access procedure and the access parameter that correspond to each TRP type.

In the method 400, the type of the synchronization raster is associated with the TRP type, so that the terminal device can quickly determine the TRP type based on a frequency scanning result, and then access the network based on the TRP type.

An embodiment of the present disclosure further provides a communication method 500. As shown in FIG. 7, the method 500 includes the following steps.

S510. A network device determines, based on first information, that the first information is associated with energy consumption of a cell, where the first information includes one or more of a common signal periodicity of the cell, an access procedure of the cell, a system information obtaining manner of the cell, and a time domain position of a transmission resource of the cell, a frequency domain position of the transmission resource of the cell, and the first information has a correspondence with at least one of the following: raster information of a synchronization signal and a type of the synchronization signal.

It should be understood that, in comparison with the method 100, the network device and a terminal device in the method 500 do not need to determine operating modes thereof.

It should be understood that, for descriptions of a type of a synchronization raster and the type of the synchronization signal, refer to the method 100. Details are not described herein again.

In a possible implementation, the network device determines, based on an association relationship #B (an example of a second association relationship) and a specific operating parameter of the cell, the type of the synchronization raster in which the synchronization signal of the cell is located. The association relationship #B is an association relationship between the type of the synchronization raster and the specific operating parameter of the cell in an operating mode.

It should be understood that, because the cell has different specific operating parameters, corresponding types of the synchronization raster are also different. In this implementation, the network device can determine, based on the specific operating parameter of the cell, the type of the synchronization raster for sending the synchronization signal. For the specific operating parameter of the cell, refer to the descriptions in the foregoing implementations. Details are not described herein again.

By way of example but not limitation, the association relationship #B includes an association relationship between the system information obtaining manner of the cell and the type of the synchronization raster. Specifically, when remaining minimum system information of the cell is actively broadcast by a network side, a corresponding synchronization raster is a first-type synchronization raster; or when remaining minimum system information of the cell is sent under triggering of a request of the terminal device, a corresponding synchronization raster is a second-type synchronization raster. In this case, if the remaining minimum system information is actively broadcast by the network side, the cell sends the synchronization signal on the first-type synchronization raster.

It should be understood that the association relationship #B can include at least two association relationships between the specific operating parameter and the type of the synchronization raster. By way of example but not limitation, the association relationship #B is shown in the following table.

TABLE 4
Example of an association relationship

| First-type synchronization | Second-type synchronization |
|---|---|
| raster | raster |
| A network side actively | A terminal device actively |
| broadcasts RMSI. | triggers sending of RMSI. |
| A common signal periodicity | A common signal periodicity |
| is 5 ms. | is 20 ms. |

It should be understood that the association relationship #B can include at least two association relationships between the synchronization raster and the specific operating parameter. By way of example but not limitation, the association relationship #B is shown in the following table:

TABLE 5
Example of an association relationship

| First-type | Second-type | Third-type |
|---|---|---|
| synchronization | synchronization | synchronization |
| raster | raster | raster |
| A common signal | A common signal | A common signal |
| periodicity is 5 ms. | periodicity is 20 ms. | periodicity is 80 ms. |

In another possible implementation, the network device determines, based on an association relationship #D (another example of a second association relationship) and a specific operating parameter of the cell in an operating mode, the type of the synchronization signal of the cell. The association relationship #D is an association relationship between the type of the synchronization signal and the specific operating parameter of the cell in the operating mode.

In this implementation, the network device can determine, based on the specific operating parameter of the cell, the type of the sent synchronization signal. For the specific operating parameter of the cell, refer to the descriptions in the foregoing implementations. Details are not described herein again.

By way of example but not limitation, the association relationship #D includes an association relationship between the system information obtaining manner of the cell and the type of the synchronization signal. Specifically, when remaining minimum system information of the cell is actively broadcast by a network side, a corresponding synchronization signal is a first-type synchronization signal; or when remaining minimum system information of the cell is sent under triggering of a request of the terminal device, a corresponding synchronization signal is a second-type synchronization signal. In this case, if the remaining minimum system information is actively broadcast by the network side, the cell sends the first-type synchronization signal. A sequence length of the first-type synchronization signal is 100 bits, and a sequence length of the second-type synchronization signal is 200 bits.

It should be understood that the association relationship #D can include at least two association relationships between the specific operating parameter and the type of the synchronization signal. For a specific example, refer to Table 4, where the type of the synchronization raster only needs to be replaced with the type of the synchronization signal. Details are not described herein again.

It should be understood that the association relationship #D can include at least two association relationships between the type of the synchronization signal and the specific operating parameter. For a specific example, refer to Table 5, where the type of the synchronization raster only needs to be replaced with the type of the synchronization signal. Details are not described herein again.

S520. The network device sends the synchronization signal. For a specific manner, refer to step S120. Details are not described herein again.

S530. The terminal device detects the synchronization signal, and determines the first information based on the synchronization signal.

In a possible implementation, the terminal device determines the specific operating parameter of the cell based on the type of the synchronization raster and the association relationship #B, where different operating parameters correspond to different energy consumption.

In another possible implementation, the terminal device determines the specific operating parameter of the cell based on the type of the synchronization signal and the association relationship #D, where different operating parameters correspond to different energy consumption.

It should be understood that a specific manner in which the terminal device determines the association relationship #B and the association relationship #D is not limited in the present disclosure.

For example, the association relationship #B and the association relationship #D are protocol-predefined.

For example, before receiving the synchronization signal, the terminal device receives system information broadcast by the network device, where the system information includes the association relationship #B and the association relationship #D.

S540. The terminal device accesses a network based on the first information.

In a possible implementation, the terminal device accesses the network based on the specific operating parameter that is of the cell and that is determined based on the type of the synchronization raster or the type of the synchronization signal.

By way of example but not limitation, if the common signal periodicity determined by the terminal device is 5 ms, the terminal device subsequently receives a common signal in a periodicity of 5 ms, to implement a subsequent access procedure based on the common signal to access the network.

By way of example but not limitation, if an RMSI receiving manner determined by the terminal device is that the network side actively performs broadcasting, the terminal device continuously detects the RMSI, to perform a subsequent access procedure based on the RMSI to access the network.

By way of example but not limitation, if the access procedure determined by the terminal device is access based on a wake-up signal, the terminal device sends the wake-up signal to the network side, to perform a subsequent access procedure to access the network.

By way of example but not limitation, if the terminal device determines the time domain position and the frequency domain position of the transmission resource, the terminal device receives and sends a signal at the time domain position and the frequency domain position, to perform a subsequent access procedure to access the network.

Based on the foregoing solution, after detecting the synchronization signal, the terminal device can determine the specific operating parameter of the cell based on the type of the synchronization signal or the raster information of the synchronization signal, and then access the network based on the specific operating parameter.

It should be understood that embodiments described in this specification may be independent solutions, or may be combined based on internal logic. These solutions all fall within the protection scope of the present disclosure. It should be understood that the steps in the foregoing embodiments are merely intended to clearly describe the technical solutions of embodiments, and an execution sequence of the steps is not limited.

It should be further understood that in some of the foregoing embodiments, a device (for example, the terminal device or the network device) in an existing network architecture is mainly used as an example for description. It should be understood that a specific form of the device is not limited in embodiments of the present disclosure. For example, all devices that can implement a same function in the future are applicable to embodiments of the present disclosure.

It may be understood that, in the foregoing method embodiments, a method and an operation implemented by a device (for example, the terminal device or the network device) may alternatively be implemented by a component (for example, a chip or a circuit) of the device.

The foregoing describes in detail the communication method provided in embodiments of the present disclosure with reference to FIG. 3 and FIG. 7. The foregoing communication method is mainly described from a perspective of interaction between the terminal device and the network device. It may be understood that, to implement the foregoing functions, the terminal device and the network device include corresponding hardware structures and/or software modules for performing the functions.

A person skilled in the art may be aware that, units and algorithm steps in the examples described with reference to embodiments disclosed in this specification can be implemented by hardware or a combination of hardware and computer software in the present disclosure. Whether a function is performed by hardware or hardware driven by computer software depends on particular applications and design constraint conditions of the technical solutions. A person skilled in the art may use different methods to implement the described functions for each particular application, but it should not be considered that the implementation goes beyond the scope of the present disclosure.

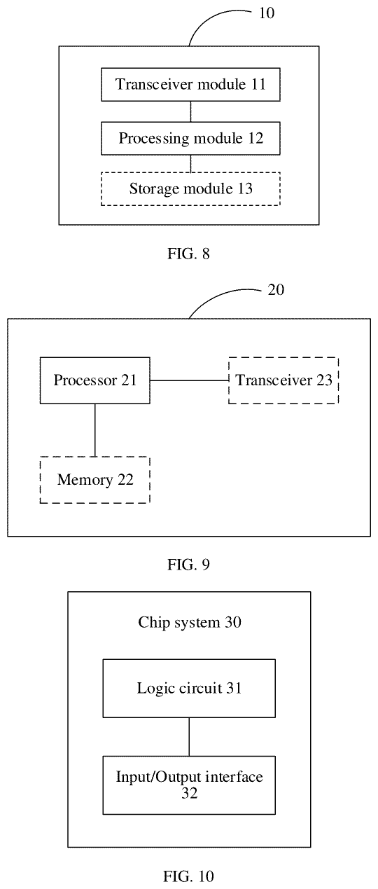

The following describes in detail the terminal device and the network device provided in embodiments of the present disclosure with reference to FIG. 8 to FIG. 10. It should be understood that descriptions of apparatus embodiments correspond to the descriptions of the method embodiments. Therefore, for content that is not described in detail, refer to the foregoing method embodiments. For brevity, details of a part of content are not described herein again.

In embodiments of the present disclosure, functional modules may be divided on the terminal device and the network device based on the foregoing method examples. For example, each functional module may be obtained through division based on a corresponding function, or two or more functions may be integrated into one processing module. The integrated module may be implemented in a form of hardware, or may be implemented in a form of a software functional module. It should be noted that, in embodiments of the present disclosure, module division is an example, and is merely logical function division. In actual implementation, another division manner may be used. An example in which each functional module is obtained through division based on a corresponding function is used below for description.

FIG. 8 is a block diagram of a communication apparatus 10 according to an embodiment of the present disclosure. The apparatus 10 includes a transceiver module 11 and a processing module 12. The transceiver module 11 may implement a corresponding communication function, and the processing module 12 is configured to perform data processing. Alternatively, the transceiver module 11 is configured to perform receiving-related and sending-related operations, and the processing module 12 is configured to perform operations other than receiving and sending. The transceiver module 11 may also be referred to as a communication interface or a communication unit.

Optionally, the apparatus 10 may further include a storage module 13. The storage module 13 may be configured to store instructions and/or data. The processing module 12 may read the instructions and/or the data in the storage module, to cause the apparatus to implement actions of a device in the foregoing method embodiments.

In a design, the apparatus 10 may correspond to the terminal device in the foregoing method embodiments, or a component (for example, a chip) of the terminal device.

The apparatus 10 may implement corresponding steps or procedures performed by the terminal device in the foregoing method embodiments. The transceiver module 11 may be configured to perform receiving-related and sending-related operations of the terminal device in the foregoing method embodiments, and the processing module 12 may be configured to perform a processing-related operation of the terminal device in the foregoing method embodiments.

In a possible implementation, the transceiver module 11 is configured to detect a synchronization signal; the processing module 12 is configured to determine an operating mode of a cell based on the synchronization signal, where the cell supports at least two operating modes with different energy consumption, and the operating mode of the cell has a correspondence with at least one of the following: raster information of the synchronization signal and a type of the synchronization signal; and the processing module 12 is further configured to access a network based on the operating mode of the cell.

When the apparatus 10 is configured to perform the method in FIG. 3 or FIG. 7, the transceiver module 11 may be configured to perform steps of receiving and sending information in the method; and the processing module 12 may be configured to perform a processing step in the method.

It should be understood that a specific process in which the units perform the foregoing corresponding steps has been described in detail in the foregoing method embodiments, and for brevity, details are not described herein again.

In another design, the apparatus 10 may correspond to the network device in the foregoing method embodiments, or may be a component (for example, a chip) of the network device.

The apparatus 10 may implement corresponding steps or procedures performed by the network device in the foregoing method embodiments. The transceiver module 11 may be configured to perform receiving-related and sending-related operations of the network device in the foregoing method embodiments, and the processing module 12 may be configured to perform a processing-related operation of the network device in the foregoing method embodiments.

In a possible implementation, the processing module 12 is configured to determine a first type of a synchronization signal based on an operating mode of a cell, where the cell supports at least two operating modes with different energy consumption, and the operating mode of the cell has a mapping relationship with at least one of the following: raster information of the synchronization signal and a type of the synchronization signal; and the transceiver module 11 is configured to send the synchronization signal.

When the apparatus 10 is configured to perform the method in FIG. 3 or FIG. 7, the transceiver module 11 may be configured to perform steps of receiving and sending information in the method; and the processing module 12 may be configured to perform a processing step in the method.

It should be understood that a specific process in which the units perform the foregoing corresponding steps has been described in detail in the foregoing method embodiments, and for brevity, details are not described herein again.

It should be further understood that the apparatus 10 herein is embodied in a form of a functional module. The term “module” herein may be an application-specific integrated circuit (ASIC), an electronic circuit, a processor (for example, a shared processor, a dedicated processor, or a group processor) configured to execute one or more software or firmware programs, a memory, a merged logic circuit, and/or another suitable component that supports the described function. In an optional example, a person skilled in the art may understand that the apparatus 10 may be specifically a mobility management network element in the foregoing embodiments, and may be configured to perform procedures and/or steps corresponding to the mobility management network element in the foregoing method embodiments. Alternatively, the apparatus 10 may be specifically the terminal device in the foregoing embodiments, and may be configured to perform procedures and/or steps corresponding to the terminal device in the foregoing method embodiments. To avoid repetition, details are not described herein again.

The apparatus 10 in the foregoing solutions has a function of performing corresponding steps performed by a device (for example, the terminal device and the network device) in the foregoing methods. The function may be implemented by hardware, or may be implemented by hardware executing corresponding software. The hardware or the software includes one or more modules corresponding to the foregoing function. For example, the transceiver module may be replaced with a transceiver (for example, a sending unit in the transceiver module may be replaced with a transmitter, and a receiving unit in the transceiver module may be replaced with a receiver), and another unit like the processing module may be replaced with a processor, to respectively perform receiving and sending operations and processing-related operations in the method embodiments.

In addition, the transceiver module 11 may alternatively be a transceiver circuit (for example, may include a receiving circuit and a sending circuit), and the processing module may be a processing circuit.

FIG. 9 is a diagram of another communication apparatus 20 according to an embodiment of the present disclosure. The apparatus 20 includes a processor 21. The processor 21 is configured to execute a computer program or instructions stored in a memory 22, or read data/signaling stored in the memory 22, to perform the methods in the foregoing method embodiments. Optionally, there are one or more processors 21.

Optionally, as shown in FIG. 9, the apparatus 20 further includes the memory 22, and the memory 22 is configured to store the computer program or the instructions and/or the data. The memory 22 may be integrated with the processor 21, or may be disposed separately. Optionally, there are one or more memories 22.

Optionally, as shown in FIG. 9, the apparatus 20 further includes a transceiver 23, and the transceiver 23 is configured to receive and/or send a signal. For example, the processor 21 is configured to control the transceiver 23 to receive and/or send the signal.

In a solution, the apparatus 20 is configured to implement operations performed by the terminal device and the network device in the foregoing method embodiments.

It should be understood that, the processor mentioned in embodiments of the present disclosure may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be further understood that the memory mentioned in embodiments of the present disclosure may be a volatile memory and/or a non-volatile memory. The non-volatile memory may be a read-only memory (ROM), a programmable read-only memory (PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM includes the following plurality of forms: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA or another programmable logic device, a discrete gate or a transistor logic device, or a discrete hardware component, a memory (storage module) may be integrated into the processor.

It should further be noted that the memory described in this specification is intended to include, but is not limited to, these memories and any other memory of a proper type.

FIG. 10 is a diagram of a chip system 30 according to an embodiment of the present disclosure. The chip system 30 (or may be referred to as a processing system) includes a logic circuit 31 and an input/output interface 32.

The logic circuit 31 may be a processing circuit in the chip system 30. The logic circuit 31 may be coupled and connected to a storage unit, and invoke instructions in the storage unit, so that the chip system 30 can implement the methods and functions in embodiments of the present disclosure. The input/output interface 32 may be an input/output circuit in the chip system 30, and outputs information processed by the chip system 30, or inputs to-be-processed data or signaling information into the chip system 30 for processing.

In a solution, the chip system 30 is configured to implement operations performed by the terminal device and the network device in the foregoing method embodiments.

For example, the logic circuit 31 is configured to implement processing-related operations performed by the terminal device and the network device in the foregoing method embodiments. The input/output interface 32 is configured to implement sending-related and/or receiving-related operations performed by the terminal device and the network device in the foregoing method embodiments.

An embodiment of the present disclosure further provides a computer-readable storage medium. The computer-readable storage medium stores computer instructions used to implement the methods performed by the terminal device and the network device in the foregoing method embodiments.

An embodiment of the present disclosure further provides a computer program product, including instructions. When the instructions are executed by a computer, the methods performed by the terminal device and the network device in the foregoing method embodiments are implemented.

An embodiment of the present disclosure further provides a communication system, including the foregoing terminal device and network device.

For explanations and beneficial effects of related content in any one of the apparatuses provided above, refer to the corresponding method embodiments provided above. Details are not described herein again.

In the several embodiments provided in the present disclosure, it should be understood that the disclosed apparatus and method may be implemented in other manners. For example, the described apparatus embodiment is merely an example. For example, division into the units is merely logical function division and there may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

All or some of the foregoing embodiments may be implemented by using software, hardware, firmware, or any combination thereof. When software is used to implement the foregoing embodiments, all or a part of the foregoing embodiments may be implemented in a form of a computer program product. The computer program product includes one or more computer instructions. When the computer program instructions are loaded and executed on a computer, the procedures or functions according to embodiments of the present disclosure are all or partially generated. The computer may be a general-purpose computer, a dedicated computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like. For example, the usable medium includes but is not limited to any medium that can store program code, for example, a USB flash drive, a removable hard disk, a read-only memory (ROM), a random access memory (RAM), a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A communication method, comprising:
detecting, by a terminal device, a synchronization signal;
determining, by the terminal device, a type of energy consumption of the cell based on a detected operating mode of a cell indicated by the synchronization signal, wherein the cell supports at least two operating modes with different energy consumption, and the operating mode of the cell has a mapping relationship with at least one of the following: raster information of the synchronization signal and a type of the synchronization signal; and
accessing, by the terminal device, a network based on the operating mode of the cell.

2. The method according to claim 1, wherein determining, by the terminal device, the operating mode of the cell based on the synchronization signal comprises:
determining the operating mode of the cell based on the synchronization signal and a first association relationship, wherein the first association relationship comprises an association relationship between the raster information of the synchronization signal and the operating mode of the cell, and/or an association relationship between the type of the synchronization signal and the operating mode of the cell.

3. The method according to claim 1, wherein the raster information of the synchronization signal comprises one or more of the following:
a frequency domain offset, a frequency domain interval, and a global synchronization channel number GSCN calculation manner.

4. The method according to claim 1, wherein different types of synchronization signals have a same center frequency, and the type of the synchronization signal is identified based on one or more of the following:
a sequence type of the synchronization signal;
a sequence length of the synchronization signal; or
composition of the synchronization signal, wherein the synchronization signal comprises one or more of a primary synchronization signal PSS, a secondary synchronization signal SSS, a master information block MIB, and a timing indication signal.

5. The method according to claim 1, wherein one or more of the following of the cell vary with operating modes with different energy consumption:
a common signal periodicity of the cell, an access procedure of the cell, a system information obtaining manner of the cell, a time domain position of a transmission resource of the cell, a frequency domain position of the transmission resource of the cell, a function supported by the cell, and a hardware resource of the cell.

6. The method according to claim 2, wherein the first association relationship is protocol-defined; or
before detecting, by the terminal device, the synchronization signal, the method further comprises:
receiving a first message, wherein the first message comprises the first association relationship.

7. A communication method, comprising:
determining, by a network device, a synchronization signal based on an operating mode of a cell, wherein the cell supports at least two operating modes with different energy consumption, and the operating mode of the cell has a mapping relationship with at least one of the following: raster information of the synchronization signal and a type of the synchronization signal; and
sending, by the network device, the synchronization signal.

8. The method according to claim 7, wherein determining, by the network device, the synchronization signal based on the operating mode of the cell comprises:
determining, by the network device, the synchronization signal based on the operating mode of the cell and a first association relationship, wherein the first association relationship comprises an association relationship between the raster information of the synchronization signal and the operating mode of the cell, and/or an association relationship between the type of the synchronization signal and the operating mode of the cell.

9. The method according to claim 7, wherein the raster information of the synchronization signal comprises one or more of the following:
a frequency domain offset, a frequency domain interval, and a global synchronization channel number GSCN calculation manner.

10. The method according to claim 7, wherein different types of synchronization signals have a same center frequency, and the type of the synchronization signal is identified based on one or more of the following:
a sequence type of the synchronization signal;
a sequence length of the synchronization signal; or
composition of the synchronization signal, wherein the synchronization signal comprises one or more of a primary synchronization signal PSS, a secondary synchronization signal SSS, a master information block MIB, and a timing indication signal.

11. The method according to claim 7, wherein one or more of the following of the cell vary with operating modes with different energy consumption:
a common signal periodicity of the cell, an access procedure of the cell, a system information obtaining manner of the cell, a time domain position of a transmission resource of the cell, a frequency domain position of the transmission resource of the cell, a function supported by the cell, and a hardware resource of the cell.

12. The method according to claim 7, wherein the first association relationship is protocol-defined; or
before sending, by the network device, the synchronization signal, the method further comprises:
sending a first message, wherein the first message comprises the first association relationship.

13. A communication apparatus, comprising at least one processor, and one or more memories coupled to the at least one processor and storing programming instructions for execution by the at least one processor to perform:
detect a synchronization signal;
determine an operating mode of a cell based on the synchronization signal, wherein the cell supports at least two operating modes with different energy consumption, and the operating mode of the cell has a mapping relationship with at least one of the following: raster information of the synchronization signal and a type of the synchronization signal; and
access a network based on the operating mode of the cell.

14. The apparatus according to claim 13, wherein the determine the operating mode of the cell based on the synchronization signal comprises:
determine the operating mode of the cell based on the synchronization signal and a first association relationship, wherein the first association relationship comprises an association relationship between the raster information of the synchronization signal and the operating mode of the cell, and/or an association relationship between the type of the synchronization signal and the operating mode of the cell.

15. The apparatus according to claim 13, wherein the raster information of the synchronization signal comprises one or more of the following:
a frequency domain offset, a frequency domain interval, and a global synchronization channel number GSCN calculation manner.

16. The apparatus according to claim 14, wherein the raster information of the synchronization signal comprises one or more of the following:
a frequency domain offset, a frequency domain interval, and a global synchronization channel number GSCN calculation manner.

17. The apparatus according to claim 13, wherein different types of synchronization signals have a same center frequency, and the type of the synchronization signal is identified based on one or more of the following:
a sequence type of the synchronization signal;
a sequence length of the synchronization signal; or
composition of the synchronization signal, wherein the synchronization signal comprises one or more of a primary synchronization signal PSS, a secondary synchronization signal SSS, a master information block MIB, and a timing indication signal.

18. The apparatus according to claim 14, wherein different types of synchronization signals have a same center frequency, and the type of the synchronization signal is identified based on one or more of the following:
a sequence type of the synchronization signal;
a sequence length of the synchronization signal; or
composition of the synchronization signal, wherein the synchronization signal comprises one or more of a primary synchronization signal PSS, a secondary synchronization signal SSS, a master information block MIB, and a timing indication signal.

19. The apparatus according to claim 13, wherein one or more of the following of the cell vary with operating modes with different energy consumption:
a common signal periodicity of the cell, an access procedure of the cell, a system information obtaining manner of the cell, a time domain position of a transmission resource of the cell, a frequency domain position of the transmission resource of the cell, a function supported by the cell, and a hardware resource of the cell.

20. The apparatus according to claim 14, wherein the first association relationship is protocol-defined; or
the transceiver module is further configured to receive a first message, wherein the first message comprises the first association relationship.
